(19) United States
(12) Patent Application Publication
(10) Pub. No.: US 2004/0143460 A1
(43) Pub. Date: Jul. 22, 2004

(54) Method of combining physician and pharmaceutical care with an integrated database

(76) Inventor: Carl Marhaver, Wichita, KS (US)

Correspondence Address: Bradley P. Sylvester, Suite 300, 200 North Broadway, Wichita, KS, 67202, US

(21) Appl. No.: 10/751,173

(22) Filed: Jan. 2, 2004

Related U.S. Application Data
(60) Provisional application No. 60/437,707, filed on Jan. 2, 2003.

(51) Int. Cl. G06F 17/60

(52) U.S. Cl. 705/2

(57) ABSTRACT

A novel method of treating patients, in which the focus is on the type of ailment or malady, and the diagnosis made for the patient, for purposes of determining the fee and how to utilize a database comprising medical history of each patient. A treating physician and dispensing pharmacy coordinate their activities with each patient, so that any activity with a particular patient by either the physician or the pharmacy is entered into a shared database, with the updating of the database occurring optimally in real time. The pricing structure relates also to the type of diagnosis, being derived from a determined average of the costs for each patient with a similar diagnosis. The database information provides a new level of information for both the pharmacy and the physician, with the database being useful not only for cost analysis, but also for quality control purposes to assess the value of various treatments.

### BACKGROUND OF THE INVENTION

The present invention relates to an improved method of business, in which the evaluation, diagnosis and treatment are all interconnected with each other, and where information about the patient is available to both the physician and dispensing pharmacy. The current general method of treatment for a patient is bifurcated between the medical doctor and the dispensing pharmacy. The present invention seeks to join and meld these two aspects into a single comprehensive process and method, where both the medical physician and dispensing pharmacy benefit from this unification.

Typically, a patient receives medical attention involving examination and diagnosis from a medical doctor, or trained professional qualified to do such examinations and evaluations. Once a diagnosis is determined, the patient is prescribed a specific treatment which may include prescription medications. Typically the patient must go to a separate building or facility to obtain the prescription medications. Since the pharmacy is not part of the same treatment facility that the physician is, the dispensing pharmacy does not have access to all patient medical information, other than that proprietary information which they have likely input themselves into their own database. Generally neither the medical doctor or the dispensing pharmacy share patient information with each other, nor does either entity update a database of medical information that is jointly accessible by each other.

A lack of communication between the medical doctor and the dispensing pharmacy results in an often incomplete medical history, and does not allow for any review of what has been prescribed by the pharmacy as to whether or not undesired drug interaction might occur. Unfortunately, realization of improper drug interaction generally only comes about through the patient having such knowledge of which drugs they can or cannot take with others, and being able to provide this information to the doctor or pharmacy, and generally such information is provided only if pointedly asked for by the physician or pharmacy, through an actual investigation by the doctor and or dispensing pharmacy. Is not uncommon for the patient to suffer from negative drug interaction due to lack of information been made available to the physician and/or dispensing pharmacy. For example, some medications cannot be safely used with Ibuprofen, while others cannot be safely used with acetaminophen. The patient cannot be relied upon to necessarily know this type of negative drug interaction. Too often the means to ensure that both the doctor and dispensing pharmacy have all of the updated and proper medical information lies principally with the patient. The patient is often in a poor position to judge or even know of improper drug interactions.

What also occurs under the typical business practices, is that a separate patient database is created at each facility where the patient receives care or medication. Each separate patient database, involving a single patient, typically lacks all of information that is available through combination of all databases concerning that single patient. The updating of patient information is likewise sporadic and lacking in a complete picture of the patient, since what may be important to one health-care provider may be considered unimportant or unnecessary to the business practices involving the necessary medical information for a dispensing pharmacy. Yet, virtually all such information is usable and important in a clinical sense, when evaluating the suitability of various medications. In this situation, the dispensing pharmacy is clearly at a disadvantage to properly review the safety of the type of drugs being given to a particular patient. Likewise, unless the patient has happened to remember all information about their medical history involving all types of medications previously prescribed and currently being taken, the medical doctor has an insufficient picture about what this particular patient has been previously prescribed, and actually received. Furthermore, physicians are also hampered by many patients lack of knowledge of the specific drug(s) and dosage(s) that may have been prescribed to them by other physicians.

### SUMMARY OF THE INVENTION

The human body is in essence a complex organic machine. Treatment of the body may involve physical intervention such as surgery, but often involves the introduction and monitoring of chemical substances in the body which cause the body to react in a certain way, or which effectively combat infection or abnormalities within the blood or tissue. While there are many physical ailments that are rare and involve intensive treatment and monitoring, the vast majority of patients seeking medical attention have what would be considered routine issues, which are able to be dealt with in a fairly uniform manner for all patients within that group of patients having the same medical situation. It is the maximization of resources, along with the desire to provide the patient with the best care and availability of contact with a group of physicians, with all participants having maximum available patient medical history information which gives rise to the present invention described here.

This invention involves an improved method of dealing with and treating patients in the medical field on a regional or nationwide basis. Treatment facilities are able to receive patients which are examined and evaluated on-site by a medical doctor or similarly trained professional. Using this method, where there is more than one treatment facility, the medical doctor may be at a separate facility, but is in contact with the facility where the patient is physically present at. In some cases, the majority of medical doctors may be at a central facility, with satellite offices offering the ability to evaluate and examine the patient, but which are capable of communicating directly with the doctors at the central facility, and making that condition of the patient known to the doctors through audio or visual means. Having the doctors available through electronic connections allows a single patient to be examined in a single facility, which may not be in an area that would normally be able to support a large group of specialists, and yet have the ability to undergo further examination or review by any number of specialists through electronic communication means.

If medications are prescribed, the dispensing pharmacy is optimally located on-site and comprises a part of the overall treatment facility. Since it is part of the same treatment facility as the medical doctor, the pharmacy has access to the patient database which has the medical history of the patient contained within it. The pharmacy is able to review the entire medical history of the patient to seek out any potential problems that may exist with regard to contradictory medications. In this manner, the pharmacy is able to review what the prescribing doctor has ordered, as to whether or not potential problems exist concerning the medication ordered.

Perhaps more importantly, the medical database concerning the client's medical history is updated both by the physician and the dispensing pharmacy, which work in unison with each other to maintain the database updates. Both the doctor and the pharmacy have the same access to the joint database. In this manner, the database is updated in real time, and is as current and complete as possible.

Further, this method allows patients to be treated in a uniform manner, as well as be under a pricing structure that is fairly distributed to all patients. All entities benefit from a uniform pricing structure that is based on the diagnosis and treatment. The patient only pays for medical treatments to take care of what is actually wrong with them. The physician is paid a standard fee which covers the average work spent with a patient with the specific type of medical situation. The charges can be extremely competitive, since the database allows constant monitoring of various diagnosis and treatment costs, with the monitoring reflecting up to date information using the database that is constantly updated in real-time. The dispensing pharmacy is able to provide the highest level of service, since it is able to double check all medications dispensed to each patient along with the optimal way to detect anticipated negative drug interactions.

The pricing structure is able to remain uniform, due to the fact that the physicians do not need to be distributed physically, and those with specialty areas may remain centrally located and yet be able to interact electronically with patients at all satellite offices. This business method does not remove all access to such specialists in a physical sense, since the patients which are evaluated can be directed to visit a specialists physically, when remote review and contact is ineffectual.

The patient further benefits from having the database updated by both the physician and the pharmacy. Previously, information regarding drugs that were received from a pharmacy would have to be obtained from the pharmacy, and would comprise the medications that were prescribed and actually delivered to the patient. The remaining medical history would have to come from a physician, and the only way to combine these two databases would be to cross-reference between them. To attempt to combine these two different databases in this manner is cumbersome, since both databases have their own criteria as to what is actually the important information. The pharmacy database, standing alone, it is not concerned with the symptoms giving rise to the medication being prescribed, but is only concerned with insurance information and prior medications dispensed from that particular pharmacy. The physician on the other hand is concerned with the ongoing record of evaluations and diagnosis, and what was prescribed, but there is no record regarding what medication was actually obtained by the patient after being prescribed. If a patient fails to follow through and get a certain medication, only a crosscheck of the pharmacy records would indicate this. If a single database is used, either the pharmacy or the physician can determine the possibility of a negative drug interaction, and immediately, both the pharmacy and physician know about it through the database information.

Using a central database further supplies the patient with the ability to take his or her medical information with them, or allows them to combine medical information from one or more sources into a central database. The information may be transferred using a common diskette, or transferred via the Internet, and may be brought in by the patient, or taken with the patient if they transfer somewhere else.

### DETAILED DESCRIPTION OF THE INVENTION

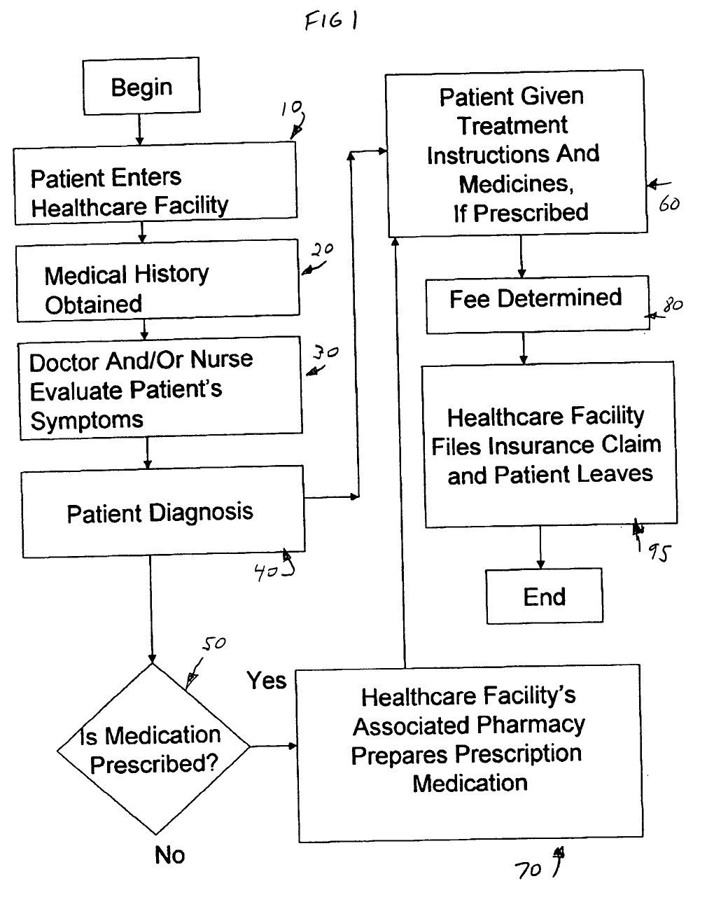

Referring now to FIG. 1, a flowchart is shown depicting one of three possible methods used with this treatment plan. At the onset, a patient enters the health care facility 10 using this novel method. The health care facility includes at least one area in which a trained professional, such as a nurse or doctor, is able to evaluate the patient, and obtain a diagnosis. The doctor may be located onsite, or be located and connected electronically with the facility so that the doctor can review the patient off site through the electronic means. The facility also includes a medical consultation area that provides the patient with an area in which information about treatment and medications may be provided. Further, the facility includes a facility that is able to dispense prescription and non prescription medications recommended by the treatment facility doctor.

Once the patient enters the health care facility, the patient encounters a member of said facility, which identifies the patient and obtains the medical history 20 applicable to the patient. If the patient is a new visitor to the facility, medical history is obtained directly from the patient, and optimally also from the previous treatment facility that has dealt with patient before. If the patient is a repeat visitor to the treatment facility, the medical history is updated so that it is current as to all medications and physical conditions.

The medical history is recorded on a central database that is accessible by all members and participants within the treatment facility that are engaged in providing diagnosis, evaluation, treatment, medication, or any type of information to the patient. While the database is in a centralized location, and the database is accessible directly by the pharmacy in the same manner as it would be accessible by the treating physician. This accessibility by both the diagnostic and pharmaceutical branches of the treatment facility provides a means whereby a second review is able to be done of the patient, regarding any medications and/or treatments that are being provided, so as to bring further assurance that there is no conflict with the prescribed treatment and medications with the prior medical history information.

The database is stored electronically, so that it can be accessed in its latest revised aspects by any member of the medical facility. This differs from the typical updates that are written in a medical file, that make it virtually impossible to share between a doctor's office and a dispensing pharmacy. The updated database, including the results of the present malady, is also provided to the patient, either by access to the physician's database or by electronic medium.

Since the database is stored electronically, updates to the database are able to be done in a real-time, while a patient is being evaluated or interviewed when they initially enter the facility. Complete updating may be accomplished if the patient has access to their medical history files that are able to be stored in a digital format on such media as a floppy disk or CD ROM. Likewise, the database in its most current form can be released or transferred to another facility electronically, through a simple a means as a transfer of the file through e-mail or other data transfer means.

The medical history information is important to obtain so as to avoid conflicting medical treatments with existing medications and/or physical problems. For example, patient allergies and adverse reactions to specific medications must be determined. For example, a common allergy to penicillin is often determined to exist for patients, and this is information that is often readily obtainable from the patient themselves when asked. Patients on specific medications must also be identified as to the medications they are taking, so as to prevent treatment with medications that would adversely affect the patient through adverse drug interactions. Another example would be where a patient who is currently taking anti-seizure medication may prohibited from taking acetaminophen, which is commonly used to treat children and other ailments.

Once the medical history is compiled, it is entered into a database that relates specifically to said patient. The data is entered in to the central database during the initial examination of patient. This will allow real-time updating for the patient's medical history. The data would be able to comprise the next, scanned documents, as well as image files. The database should comprise all possible medical history, including the history of previous treatments, and medications prescribed or recommended, as well as any digital images taken or scanned of the patient, so as to give a baseline comparison between the time when the patient first consulted the facility, as well as a comparison later on when the patient has received treatment.

The database is a shared form of patient history, that allows both the nurse and doctor to review the patient's situation, as well as allowing the pharmacy within the treatment center to properly correlate for any problematic reactive drugs that would interact with each other, or give an undesired response for the patient. Along with the medical history is the type of complaints and concerns voiced by the patient initially. This is also entered into a database relating specifically to said patient.

The patient is then evaluated 30 by a Dr. and/or nurse, or other trained professional, utilizing the database information, and an evaluation of the patient relating to the symptoms. At this stage, the patient is reviewed and evaluated physically, and also according to medical records. At this step, the physical examination comprises an evaluation of the patient. The evaluation would comprise any of the following, but would not necessarily be limited to such a limited list. Typical examination procedures would include, but not be limited to a review of the patient's temperature, examination of the ears, eyes, throat, skin tone, chest cavity and abdominal cavity.

The majority of the problems that are brought to a treatment facility in a non emergency manner generally fall into several general categories, such as ear infections, respiratory problems that might include asthma, headaches, sore throats, skeletal injuries, and superficial cuts and abrasions. Treatment is often generic for these type of general problems. Certain tests or procedures during the examination are also routine, relating to certain criteria. For example, a patient that appears to have breathing problems or a serious sinus infection, may undergo an evaluation that also includes investigation involving x-rays of the chest or sinus cavity. X-rays in such a situation would be standard and typical for this type of examination. Likewise, the typical laboratory test might also be a standard examination method, such as having a patient undergo a strep test where a severe sore throat is noted, or other necessary laboratory work. Such standard examination techniques are anticipated by the treatment center, with the costs of such examination techniques included in the overall charges to the patient. Following the evaluation, a patient diagnosis is arrived at 40, that best describes the physical condition, and typical treatment for a patient in said condition. Typically, a vast majority of patients will exhibit similar characteristics and share many common physical conditions. For example, a positive strep test would result in general medications being administered, with patient's having allergic reactions to penicillin being given alternative treatment medications. A person having been diagnosed with a sinus infection would typically be prescribed a strong antibiotic. The effort through this method is to identify and treat as many generic or standard problems in a streamlined manner.

Since a vast majority of patient diagnosis 40 would be noted as being fairly identical in scope and treatment from patient to patient, the medication prescribed 50 would also have a common dosage, related to age or weight. For example, a patient that has been diagnosed as having a sore throat that has existed for a certain period of time might be prescribed as receiving antibiotic A, which would be a common antibiotic that would be given in a great majority of similar cases. If medical history showed recent use of antibiotic A, then antibiotic B might be the prevalent choice, and be automatically prescribed. Likewise, a patient that has been diagnosed as having a sore throat with a confirmed presence of strep would receive medication C, or a non penicillin derivative medication D if the patient was allergic to penicillin. Following diagnosis 40, determination is made as to whether or not medications are prescribed 50, and if medications are so prescribed, then this information is put into the treatment center's database system and transmitted to an on-site associated pharmacy, which prepares the prescription medication 70. There may be instances in which the physical constraints of the facility to not allow a pharmacy to be directly on-site with the examination area. In such case, the pharmacy could be located nearby, but would have the same access to the medical history database as if it was a physically connected part of the facility. Further, if the patient chose to use a pharmacy that was not part of the directly associated pharmacies with the treatment center, but instead chose to obtain their prescription medication offsite, access to the database by this remote pharmacy could be allowed, especially in the event that the remote pharmacy updates the database by either physically entering the update information themselves, or transmitting the update information to the treatment facility itself. In the event the medication is nonprescription, the medication dispenser or pharmacy can also make this medication available for the patient in a similar manner as prescribed.

Following the patient diagnosis 40, the treatment information and instructions are provided to the patient 60. In this procedural step 60, the patient is informed of the optimal treatment guidelines, and if medications are being ordered or prescribed, the patient is likewise informed of the prescription dosage, and also advised of typical side effects. This step of informing the patient may occur prior to the patient actually receiving any prescribed medication, or concurrently with the receiving of said prescribed medication. If medications are prescribed, during the diagnosis stage 40, the person making the diagnosis may provide both the diagnosis and treatment recommendations along with medications to be used to the patient in a relaxed manner. This is contrasted by the typical manner of business, in which a doctor prescribes medication and the patient takes the prescription to a pharmacy who has no idea, or at the very least a limited knowledge of the medical history regarding the patient. In the routine business practices and methods, pharmacies are only able to provide general information that is applicable to all patients. Use of the database allows the pharmacy to become aware of specific needs regarding the patient, instead of simply handing the prescription medication to the patient with a quick review of the dosage by a pharmacist who has other prescriptions to fill. In the business method described here come, the medical information is able to be reviewed with the patient by the treatment facility a which has the ability to spend as much time as needed to properly educate the patient. If the patient instructions have the capability of being given earlier, or are able to be given while the prescription is being filled, the patient will be a better position and situation to receive the medication and understand its limitations, potentially dangerous drug interactions, and the dosage requirements. In this situation, the doctor and/or nurse may be able to supply this information to the patient.

If both the doctor and the pharmaceutical area of the treatment facility have joint access to the database, information tailored to the patient is more easily able to be provided, if the database suggests some type of warning or information that would be considered unique as compared to other individuals at the treatment facility. Therefore, by using the database regularly, both the physician and pharmacist will be able to communicate any changes, modifications, or treatment provided back and forth to each other using the database. Therefore, this novel process allows for the only known method for a direct three sided consultation between the diagnosing physician, a pharmacist and the patient.

If the treatment instructions and medications are provided to the patient at the on-site treatment facility, the patient has an opportunity to better receive instructions regarding the medications. Further, since the patients themselves receive any necessary medications at the treatment facility, they are able to forego an additional trip to a pharmacy. As a result, both the proper medication is received, along with an opportunity to receive a thorough instruction as to care and further treatment, including medication. The evaluation 30 has costs that are in put into the database system, along with information regarding the patient diagnosis 40, which also has its own costs to be likewise input into the database. The health care pharmacy will further add additional costs for the patient into the database, depending on the charges that are appropriate for the specific medication. The costs for the evaluation, diagnosis and prescribed medications are combined for a total fee determination 80, which is then provided to patient who pays a single fee for all services and medications. The health care facility typically would file necessary insurance claims and paperwork, as is commonly done in the industry.

One benefit of this method, is to establish a set fee for each type of diagnoses and treatments irrespective of the actual evaluation costs and medications, based on the frequency or reoccurrence of similar conditions/treatment in a plurality of individuals. For example, a diagnosis of strep would necessarily have included in it the costs of laboratory tests that would be necessary in a certain percentage of the patients. Whether or not the test is performed may be irrelevant, since it is included in the set fee in relation to the frequency used to establish the average cost for the diagnosis. For example, strep may be determined where a sibling has strep, and the same conditions are manifested in the patient being examined, thus leading to the diagnosis of strep without having the test performed to corroborate the diagnosis. Another example would be where pneumonia has been detected, as part of the patient diagnosis 40, a standardized fixed cost would include the typical x-ray costs that would normally be incurred by a certain percentage of patients that receive such a diagnosis. In such a pricing method, the incentive to order expensive tests without sufficient reason is removed, since the typical tests that are to be performed at a certain percentage costs that is automatically featured in to the costs for each patient with a similar diagnosis. The patient's fees and costs are directly routed to the database.

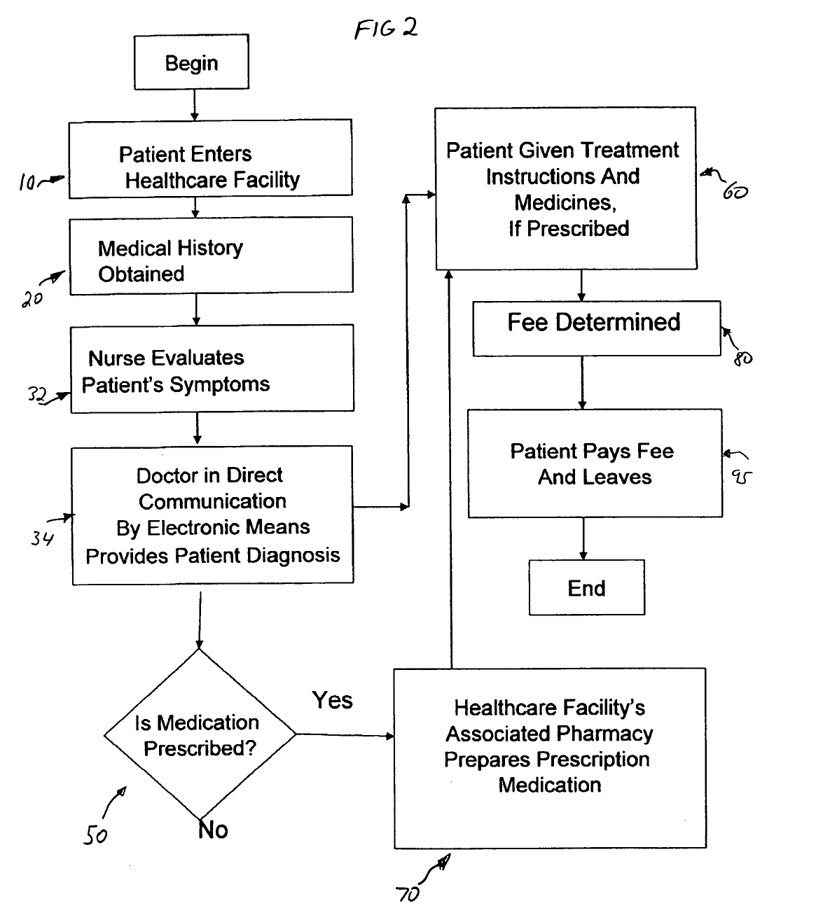

An example of the method used to set the standard fee for a specific diagnosis and treatment is shown in the area of ear infections. Patients that are determined to have an ear infection, are typically children, with such a diagnosis being made through a visual examination, with the medication prescribed being fairly standard from patient to patient. Since many of these ear infection diagnosis 40 have standard methods for detection and standard medications for treatment, the general costs/fees for them can be determined as a total fee for a group of afflicted patients divided by the number of patients. With the amount determined per individual as an average, the person receiving the evaluation diagnosis and treatment is charged a set fee that is commensurate with other individuals within the same afflicted group. Other types of typical medical complaints and treatments are able to be similarly configured within the pricing policy. A variation to the diagnosis and evaluation steps shown in FIG. 1, and designated as evaluation step 30 is shown in FIG. 2, in which the evaluation step 30 in FIG. 1 is bifurcated into a two step method, in which the initial evaluation of the patient is done by a nurse or similarly trained professional. In FIG. 2, the nurse receives and reviews the medical history, and also does the physical examination of the patient. The physical examination of the patient by the nurse is a requirement for the method step in which the nurse evaluates the patients symptoms 32. Optimally, the medical history is concurrently reviewed by the nurse, who then can communicate the findings and information to a secondary physician, where the secondary physician comprises a doctor or suitable professional that is authorized to provide a final diagnosis and treatment plan.

As FIG. 2 indicates, the doctor need not be physically present at the examination of the patient, but is able to conduct their review of the evaluation by the nurse 32, based on the medical history that was obtained 20 and the physical evaluation 32. Again, since a vast number of cases have similar affliction indicators and proscribed treatments, the diagnosis and treatment for a group of patients exhibiting similar conditions will be quite similar. For example, in a situation where a contagious disease is present in the community, it is possible that the majority of patients seeking medical help during a specific time period will all exhibit the same symptoms. Evaluation by the nurse 32 will be similar from patient to patient, and with the prevalence of the contagious disease known, the final patient diagnosis may be properly given 34 where the doctor is able to make such a determination through electronic communication. The technology is clearly available whereby the electronic means in step 34 would comprise audio communication as well as visual communication. The transfer of images of the patient taken during the nurse's evaluation 32 to the doctor allows the doctor to view the necessary portions of the physical examination. Diagnosis 34 is available for virtually every physical condition using digital imaging and text data transfer.

The benefits shown by FIG. 2 to allow a group of specialist doctors, which would also include those doctors which specialize in the area of general practice or those who deal specifically with adolescents or infants, to be available for more than one physical location. An example would be a situation where a chain of facilities might have a central office area where the doctors are in one physical area, with multiple satellite offices in a specific region all indirect communication via electronic means with the doctors. Satellite offices will have nurses or trained professionals which can do the initial patient evaluation. This allows a large patient group to have access to various doctors as needed according to the specific patient needs. When the nurse evaluates the patient's symptoms 32, many of these patients will fall within the typical or standard group of patients that have a common set of symptoms. The example being again the incidence of strep, earache, or other common malady. These patients may be properly referred to a doctor who typically deals with the subject matter, such as a doctor specializing in general practice. If the nurse evaluates the patient's symptoms 32 and determines that the patient's symptoms do not fall within the typical group of symptoms seen, or where the symptoms indicate an unusual physical situation, requiring the review of a specialist, or where the symptoms themselves indicate a serious condition, these patients may be classified as unique patients and routed to a specialty physician. For example, the patient with a pre-existing physical condition such as genetic disorders, or physical conditions such as AIDS or other permanent or semi permanent physical conditions, could be routed to a specialty physician who deals with the subject matter unique to a small target group of patients. “Routed” should be interpreted to include data sent to physicians/doctors, as well as the patient themselves physically being sent to the specialist personally.

Under this method of availability of physicians to patients, a larger number of specialty physicians is available to a larger segment of the population, and can concentrate on patients which actually need their services as determined by a nurse or trained professional. The step where the nurse evaluates the patients symptoms 32 alleviates unnecessary time that a patient might otherwise take up with a specialty physician, where the patient only requires ordinary care and treatment in a general practice sense. Likewise, where the patient exhibits unique symptoms, they are able to be diagnosed through the initial evaluation 32 and immediately directed to an appropriate physician for their specific physical needs. Specialists are available more readily to the patient, since only a central group of doctors is required, where the doctors are all available with their individual specialty to all potential patients. This effectively frees up the physician's time, so that they are able to deal with patients that they are trained specifically for, which makes the specialty physician more accessible, as well as the patient being directed to the proper type of medical care. Such a method of business would provide exceptional health care options over a wider region and would typically be able to support multiple health care centers that each had its own array of specialty physicians. This sharing of physicians to satellite offices allows the benefits of specialty care to be distributed more effectively to a larger population. Clearly, this business method includes the physical evaluation of a patient by a doctor in addition to the nurse's evaluation, where such further on-site evaluation is necessary. Where the patient is routed to a specialty doctor 36, this would include not only the routing of the patient in initial examination information to a specialty doctor, but would also include physically directing the patient to the location where the doctor is at.

The business method provided here further benefits patients so that the normal evaluation techniques involves the review of patient examinations electronically. Since this is a standard practice technique, where the doctor provides a diagnosis electronically 34, numerous physicians can be consulted in situations where the patient exhibits extremely unique physical symptoms which do not directly correlate with a standard diagnosis and treatment. Since the physicians in this method of business are readily available through electronic communication, more than one doctor is easily obtained where the opinions of more than one doctor are necessary. Therefore, this method encourages physician involvement, rather than insulating physicians from the involvement in the diagnosis.

In FIG. 2, after the diagnosis is reached and/or confirmed by the doctor 34, the patient is apprised of the treatment instructions and medications to be used 60. Concurrently with this step is that the pharmacy is able to receive prescription information, or non prescription medication information and prepare the prescription medication 70 so that it is available immediately to the patient prior to them leaving the facility. The determination of the fee 80 may be made on a variable scale, where the diagnosis comprised an unusual situation involving more than one physician, or physicians involving highly specialized areas. For example, consulting more than one physician may have a set fee that is higher than the situation where only a single physician is consulted. Medications also can vary the fee according to their individual costs, but the fee that is determined 80 is so determined only according to the diagnosis and treatment ordered. In such a situation, the patient is well aware of the fee, and is able to pay the fee and leave the facility 95 in a very streamlined manner. It should be understood that the fee being paid in step 95 would also necessarily include any determination with regard to insurance coverage. This determination and type of payment plans are standard in the industry and are utilized by virtually every pharmacy. The difference between the existing payment methods is that previously separate fees were required for a physician and the pharmacy. Under this new plan, the necessary fees are computed from both areas and are incorporated into a single fee for the patient. This method therefore encourages patients to receive the proper medicine and treatment instructions.

The fact that the patient actually received certain medications gives a higher likelihood that the medications were used. The information regarding medications received is also put into the medical history database, giving rise to further accuracy regarding subsequent patient history.

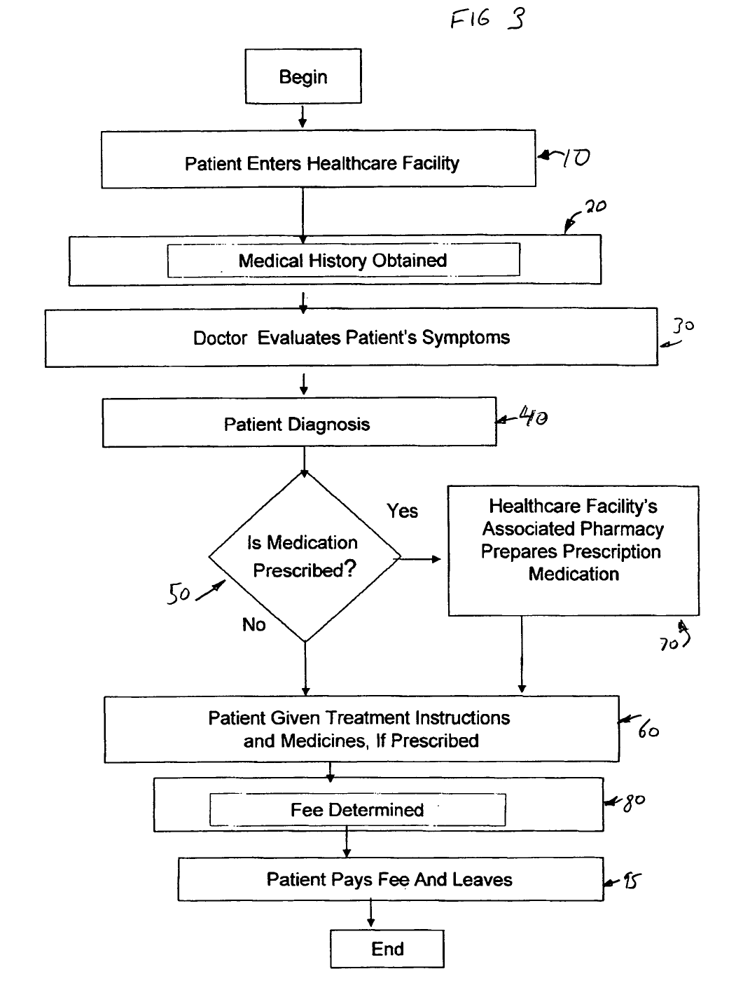

FIG. 3 exhibits the most simplistic method of accomplishing the optimal health care and treatment benefits within the scope of this invention. A doctor does the evaluation 30 and diagnosis 40. This situation would arise where the doctor is on site, and the patient is not at a satellite facility.

In all methods, the fee determined for each patient is derived from an average ascertained from using the information of all patients with a similar diagnosis. The patients are therefore separated into distinct groups, having similar diagnosis. The grouping is for fee determination purposes, and once a suitable group is determined, the average of all such patient costs within this group are readily determined by dividing the total costs required by the number of patients. Variable costs can cause the set charges, made by the treatment facility to change.. For example, if medications suddenly increase in cost, or decrease in cost, this modification to the overall costs within the group can be redetermined, giving a new average for the group. The pharmacy therefore inputs the cost of the medication dispensed into the database each time the medication is dispensed. Any substantial changes in cost can allow the database to be reviewed, and a new average fee set, to account for the change in base costs. This allows a treatment facility to remain extremely competitive, as well as allow insurance companies or government agencies to determine what costs are realistic to cover.

This novel method therefore provides for a new method to gather quality assured clinical data for a fact of this of drugs against numerous illnesses, since the prescribing physician and the pharmacist can jointly evaluate the diagnosis, the medicine which is prescribed, the delivery of the medicine to the patient, as well as update the patient's medical history during both the evaluation and medication dispensing phase of the treatment. Therefore, this method will also allow pharmaceutical developers, clinical researchers, and the United States Food and Drug Administration to better evaluate the safety of drugs across time and across patient populations and across patient maladies and drug-to-drug interactions well beyond the capability of present clinical trial protocols.

Another advantage of this process is realized through the grouping of the costs for each category of symptoms, tests, diagnoses, as well as medications and treatments prescribed. The grouping of costs allows a single company to provide one or more separate treatment facilities, that are jointly connected with regard to patient information, costs and all aspects which promote uniformity among patients. In this manner, a regional or nationwide strategy can be properly developed, which would optimize a delivery of the services available to the patient, a standardization of treatments and costs, as well as a uniformity of prescription medications being dispensed, with all of this information able to be in put into a single database that is updated by all entities involved in the treatment and care of the patient.

Another advantage of this process is realized by the insurers of patients and the payers of insurance claims including HMO's, health care insurance providers, and employer's providing health care insurance through the grouping of the costs for each category of symptoms, tests, diagnoses, as well as medications and treatments prescribed. Using this method the effectiveness and costs of medical facilities and physicians, specific drugs as prescribed for specific diagnoses can be ascertained as well as the possible over-prescription of certain drugs by specific doctors.

I claim:

1. A method of combining physician and pharmaceutical care with an integrated data base, comprising:
a. compiling a central database containing medical information about a patient, in which the database is accessible by an examining physician and a dispensing pharmacy;
b. evaluating the patient's present condition by a qualified person in a treatment facility, with a person in the treatment facility using the information in the database to arrive at a diagnosis;
c. alerting the dispensing pharmacy by the physician providing the diagnosis, of any medications prescribed;
d. accessing the database by the pharmacy prior to the dispensing of prescription drugs; and
e. updating the database by the pharmacy of the medications actually dispensed to the patient.

2. A method of combining physician and pharmaceutical care with an integrated data base, as recited in claim 1, in which the treatment facility updates the medical history of the patient following diagnosis, and prior to alerting the dispensing pharmacy by the physician providing the diagnosis, of any medications prescribed.

3. A method of combining physician and pharmaceutical care with an integrated data base, as recited in claim 1, in which the evaluation of the patient is done initially by a nurse or other similarly trained professional, with the diagnosis and prescribing of medication performed by a physician.

4. A method of combining physician and pharmaceutical care with an integrated data base, as recited in claim 1, in which the physician is off-site from the location where the patient is being evaluated, and where the physician is contacted by the treatment facility through electronic means.

5. A method of combining physician and pharmaceutical care with an integrated data base, as recited in claim 1, in which the fee is determined for the patient following the diagnosis, and where the fee is based on the average fee for the type of diagnosis that the patient receives.

6. A method of combining physician and pharmaceutical care with an integrated data base, as recited in claim 1, in which the person doing the evaluation determines that the patient requires a specialty physician, and directs the patient to a specialty physician for diagnosis.

7. A method of combining physician and pharmaceutical care with an integrated data base, as recited in claim 1, in which the dispensing pharmacy reviews the patient database regarding negative drug interaction of the medication being currently dispensed, prior to the actual dispensing of the medication.

8. A method of combining physician and pharmaceutical care with an integrated data base, comprising:
a. compiling a central database containing medical information about a patient, in which the database is accessible by an examining physician and a dispensing pharmacy;
b. evaluating the patient's present condition by a qualified person in a treatment facility, where the treatment facility comprises multiple locations;
c. providing the evaluation information to a physician, who is able to access the information in the database with the evaluation information to arrive at a diagnosis;
d. updating the database for the patient;
e. alerting the dispensing pharmacy by the persons responsible for issuing the diagnosis, of any medications prescribed;
f. accessing the database by the pharmacy prior to the dispensing of prescription drugs; and
g. updating the database by the pharmacy of the medications actually dispensed to the patient.

9. A method of combining physician and pharmaceutical care with an integrated data base, as recited in claim 8, in which the treatment facility has specialty physicians within the treatment facility able to be contacted by other treatment facility evaluators, with the contact including at least one of the following: audio contact; text contact through the Internet; or visual images capable of being sent through electronic means.

10. A method of combining physician and pharmaceutical care with an integrated data base, as recited in claim 8, in which the evaluation of the patient is done initially by a nurse or other similarly trained professional, who determines whether or not contact with the physician requires remote electronic contact or physical contact.

11. A method of combining physician and pharmaceutical care with an integrated data base, as recited in claim 8, in which the physician is off-site from the location where the patient is being evaluated, and where the physician is contacted by the treatment facility through electronic means.

12. A method of combining physician and pharmaceutical care with an integrated data base, as recited in claim 8, in which the fee is determined for the patient following the diagnosis, and where the fee is based on the average fee for the type of diagnosis that the patient receives.

13. A method of combining physician and pharmaceutical care with an integrated data base, as recited in claim 8, in which the person doing the evaluation determines that the patient requires a specialty physician, and directs the patient to a specialty physician for diagnosis.

14. A method of combining physician and pharmaceutical care with an integrated data base, as recited in claim 8, in which the dispensing pharmacy reviews the patient database regarding negative drug interaction of the medication being currently dispensed, prior to the actual dispensing of the medication.

15. A method of combining physician and pharmaceutical care with an integrated data base, with a uniform fee structure, in which a fee is established that is directly related to a specific type of diagnosis.

16. A method of combining physician and pharmaceutical care with an integrated data base, with a uniform fee structure, as recited in claim 15, in which both the treating physician and dispensing pharmacy provide updates to a database, where said database is used to provide information about costs for each patient.

17. A method of combining physician and pharmaceutical care with an integrated data base, with a uniform fee structure, as recited in claim 15, in which the pharmacy updates the database regarding the medications actually dispensed to the patient and the actual costs of the medications, and determines the total cost for each patient of a particular diagnosis, and then averaging the cost per patient for each type of diagnosis.

18. A method of combining physician and pharmaceutical care with an integrated data base, with a uniform fee structure as recited in claim 15, in which the pharmacy alerts the treatment center of any new increases in medication costs.

19. A method of combining physician and pharmaceutical care with an integrated data base, in which the patients are grouped according to their diagnosis for purposes of setting fees, and quality control evaluations.

20. A method of combining physician and pharmaceutical care with an integrated data base, in which the patients are grouped according to their diagnosis, as recited in claim 19, with the effectiveness of treatment determined for the patient group over a period of time.

21. A method of combining physician and pharmaceutical care with an integrated data base, with a uniform fee structure, as recited in claim 19, in which both the treating physician and dispensing pharmacy have access to a database, and provide updates to a database, where said database comprises medical history of each patient contained within it.
